(19) United States
(12) Patent Application Publication
(10) Pub. No.: US 2022/0092836 A1
(43) Pub. Date: Mar. 24, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventor: Yuzuru SUZUKI, Kanagawa (JP)

(73) Assignee: FUJIFILM Business Innovation Corp., Tokyo (JP)

(21) Appl. No.: 17/225,107

(22) Filed: Apr. 8, 2021

(30) Foreign Application Priority Data
Sep. 18, 2020 (JP) 2020-157134

(51) Int. Cl. G06T 11/60; G06T 11/00

(52) U.S. Cl. CPC G06T 11/60; G06T 11/001

(57) ABSTRACT

An information processing apparatus includes a processor configured to extract, for each of multiple ranges, an outline of each of areas having a common range of color information from an original image in a raster format, generate, for each area, an image in a vector format showing the extracted outline, generate intermediate images in the raster format using the outline shown by the generated image in the vector format, and when a defect occurs in the area after the generated intermediate images are integrated, generate an image as the original image, the image having undergone interpolation of the defect and integration of the intermediate images.

### CROSS-REFERENCE TO RELATED APPLICATIONS

This application is based on and claims priority under 35 USC 119 from Japanese Patent Application No. 2020-157134 filed on Sep. 18, 2020.

### BACKGROUND

### (i) Technical Field

The present disclosure relates to an information processing apparatus and a non-transitory computer readable medium storing a program.

### (ii) Related Art

There is a technique to convert a raster image to a vector image. For instance, Japanese Unexamined Patent Application Publication No. 2007-109177 describes a technique that determines a representative color based on the appearance color in a predetermined area image having a predetermined attribute included in an original image, extracts the outline of each color image having the determined representative color and the edge images in the predetermined area image, corrects the extracted outline based on the extracted edge images, and generates vector data of the predetermined area image using the corrected outline.

### SUMMARY

However, even with the technique of Japanese Unexamined Patent Application Publication No. 2007-109177, a gap occurs between the outline of an area shown in a vector image and the outline of the same area shown in a raster image. Even when a vector image is expanded or contracted, the image quality is maintained. However, for instance, when a gap is present in an original vector image and the vector image is expanded, the gap is increased and revealed.

Thus, aspects of non-limiting embodiments of the present disclosure relate to an information processing apparatus that, when the outline of an area in a raster image is represented by a vector image, reduces the gap between the outlines represented by both images.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to extract, for each of a plurality of ranges, an outline of each of areas having a common range of color information from an original image in a raster format, generate, for each area, an image in a vector format showing the extracted outline, generate intermediate images in the raster format using the outline shown by the generated image in the vector format, and when a defect occurs in the area after the generated intermediate images are integrated, generate an image as the original image, the image having undergone interpolation of the defect and integration of the intermediate images.

### BRIEF DESCRIPTION OF THE DRAWINGS

Exemplary embodiments of the present disclosure will be described in detail based on the following figures, wherein:

FIG. 1 is a diagram showing the hardware configuration of an image processing apparatus according to an exemplary embodiment;

FIG. 2 is a diagram showing the functional configuration implemented by the image processing apparatus;

FIG. 3 is a graphic showing an example of an original image;

FIGS. 4A to 4C are graphics each showing an example of an outline of an extracted hue area;

FIGS. 5A to 5C are graphics each showing an example of points on the outline of the extracted hue area;

FIGS. 6A to 6C are graphics each showing an example of a generated vector image;

FIG. 7 is a graphic showing an example of an image which integrates generated intermediate images;

FIG. 8 is a graphic showing an example of an image which illustrates a defect;

FIGS. 9A and 9B are graphics each showing an example of an intermediate image which has undergone expansion processing;

FIG. 10 is a flowchart showing the operation steps of conversion processing;

FIG. 11 is a graphic showing an example of interpolation processing in a modification;

FIG. 12 is a graphic showing an example of an image which illustrates a defect in the modification; and

FIGS. 13A and 13B are each a table showing an example of a hue range table.

### DETAILED DESCRIPTION

### [1] Exemplary Embodiment

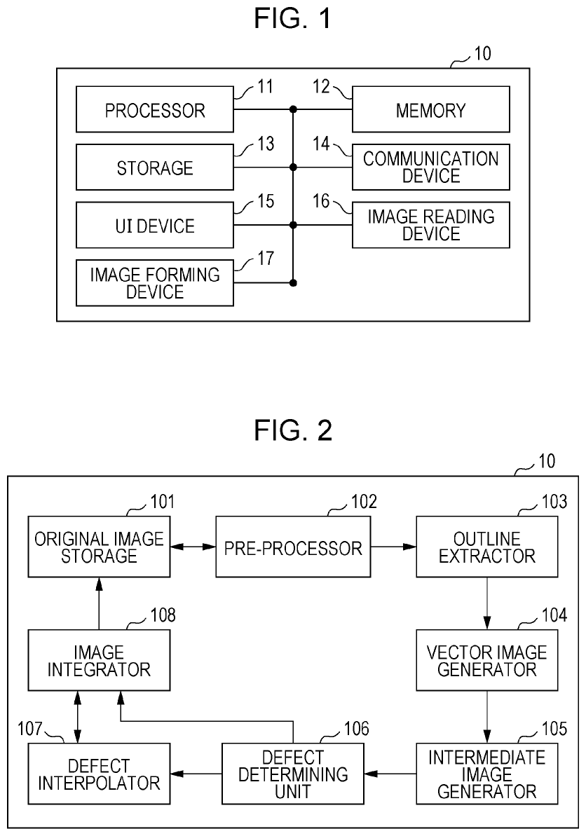

FIG. 1 is a diagram showing the hardware configuration of an image processing apparatus 10 according to an exemplary embodiment. The image processing apparatus 10 is an apparatus that performs processing of converting an image (hereinafter referred to as a “raster image”) in a raster format to an image (hereinafter referred to as a “vector image”) in a vector format. The image processing apparatus 10 is a computer including a processor 11, a memory 12, a storage 13, a communication device 14, a user interface (UI) device 15, an image reading device 16, and an image forming device 17.

For instance, the processor 11 has an arithmetic unit such as a central processing unit (CPU), a register and a peripheral circuit. The memory 12 is a recording medium readable by the processor 11, and includes a random access memory (RAM) and a read only memory (ROM).

The storage 13 is a recording medium readable by the processor 11, and includes, for instance, a hard disk drive or a flash memory. The processor 11 controls the operation of each hardware by executing the programs stored in the ROM and the storage 13 using the RAM as a work area. The communication device 14 is a communication unit that has an antenna and a communication circuit, and performs communication via a communication line 2.

The UI device 15 is an interface provided to a user who utilizes the device. The UI device 15 has, for instance, a display which is a display unit, and a touch screen having a touch panel provided on the surface of the display, and displays an image as well as receives an operation from the user. In addition, the UI device 15 has an operation device such as a keyboard, other than the touch screen, and receives an operation to the device.

The image reading device 16 is hardware (so-called scanner) that reads an image on a medium such as paper, and also an image reading unit that reads an image from a medium set to the device. The image forming device 17 is a so-called printer that forms an image on a medium such as paper, and is specifically an image forming unit that forms an image on a medium by transferring and fixing the image onto the medium, for instance, by an electrophotographic system while transporting the medium set to the device.

The functions described below are implemented by the processor 11 executing a program to control each unit. The operation performed by each function is also represented as the operation performed by the processor 11 that implements the function.

FIG. 2 shows the functional configuration implemented by the image processing apparatus 10. The image processing apparatus 10 includes an original image storage 101, a pre-processor 102, an outline extractor 103, a vector image generator 104, an intermediate image generator 105, a defect determining unit 106, a defect interpolator 107, and an image integrator 108.

The original image storage 101 stores an original raster image to be converted to a vector image, as an original image. The original image storage 101 stores a raster image generated by the apparatus or a raster image transmitted from an external device as an original image.

The pre-processor 102 preprocesses an original image in a raster format stored in the original image storage 101. For instance, the pre-processor 102 performs edge preservation and noise reduction processing, subtractive color processing, color division processing, and color layer division processing as the pre-processing. The edge preservation and noise reduction processing are processing of removing noise as well as preserving edges so that the edges do not become smooth due to the effect of the noise reduction.

The subtractive color processing is processing of reducing the number of colors in an original image. In general, the subtractive color processing is known as a K-means method or a median cut method. The color division processing herein divides the original image into pixel areas having a common range of color information such as hue and brightness. The color information represents the characteristics of the color components of a pixel, specifically, hue, brightness, chroma, and luminance.

For instance, the pre-processor 102 divides the value of an angle indicating a hue into a predetermined number of ranges in a hue circle (for instance, divides the value into 36 ranges every 10 degrees), and divides the original image into pixel areas in which the hue value is included in a corresponding range. The color layer division processing generates a color layer for each hue range, the color layer representing an area obtained by division by the color division processing. In the exemplary embodiment, a description is given by using the hue as the color information for performing the color division processing. However, the color division may be performed using other information, such as chroma, brightness or luminance, which indicates the characteristics of the color of a pixel.

The original image which has undergone the preprocessing by the pre-processor 102 is referred to as a “preprocessed image”. The pre-processor 102 supplies the preprocessed image to the outline extractor 103. The outline extractor 103 extracts the outline of each area shown in color layers included in the supplied preprocessed image, thereby extracting the outline of each area having a common hue range from the original image in a raster format for multiple hue ranges.

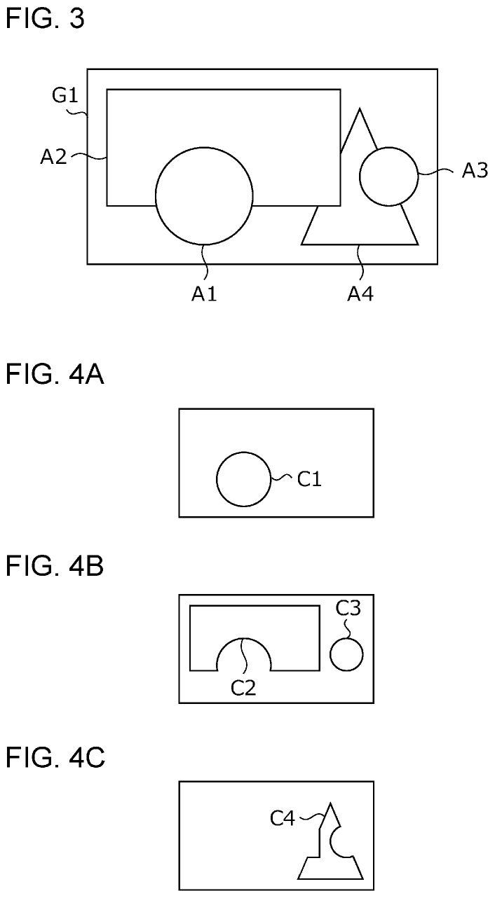

FIG. 3 shows an example of an original image. In FIG. 3, an original image G1 is shown, which includes a circular hue area A1, a quadrilateral hue area A2, a circular hue area A3, and a triangular hue area A4. The hue areas A2 and A3 among those areas are the areas represented by the color in a common hue range. The hue area A1 is superimposed on the hue area A2, and the hue area A2 and the hue area A3 are superimposed on the hue area A4.

FIGS. 4A to 4C each show an example of an outline of an extracted hue area. In FIG. 4A, an outline C1 of the hue area A1 is shown, which is extracted by the outline extractor 103. Similarly, in FIG. 4B, outlines C2 and C3 of the hue areas A2 and A3 are shown, which have a common hue range. In FIG. 4C, an outline C4 of the hue area A4 is shown.

In addition, the outline extractor 103 extracts points at characteristic positions on an extracted outline.

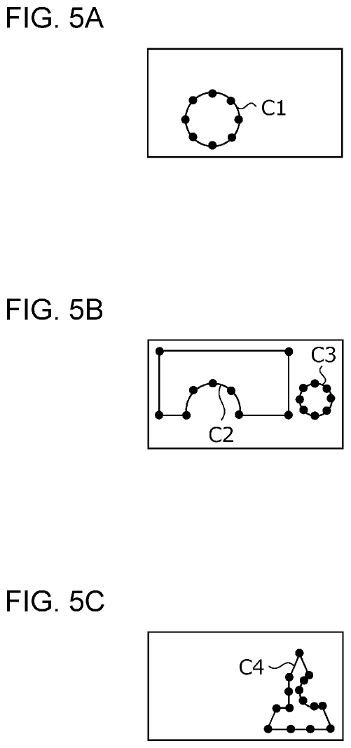

FIGS. 5A to 5C each show an example of points on the outline of the extracted hue area. In FIG. 5A, the points on the outline C1 of the hue area A1 are shown. Similarly, in FIG. 5B, the outlines C2 and C3 of the hue areas A2 and A3 are shown, and in FIG. 5C, the outline C4 of the hue area A4 is shown.

The outline extractor 103 supplies outline data to the vector image generator 104, the outline data indicating the outline of each area in each extracted hue range and the points. The vector image generator 104 generates a vector image for each area, the vector image showing the outline indicated by the supplied outline data, in other words, the outline extracted by the outline extractor 103. Using a well-known technique to generate a vector image from a raster image, the vector image generator 104 generates a vector image showing the extracted outline for each area in each hue range.

The vector image generator 104 supplies the generated vector image to the intermediate image generator 105. The intermediate image generator 105 generates an intermediate image in a raster format using the outline shown by the supplied vector image, in other words, by the vector image generated by the vector image generator 104. Using a well-known technique to generate a raster image from a vector image, the intermediate image generator 105 generates a raster image as the intermediate image from the supplied vector image for each hue range.

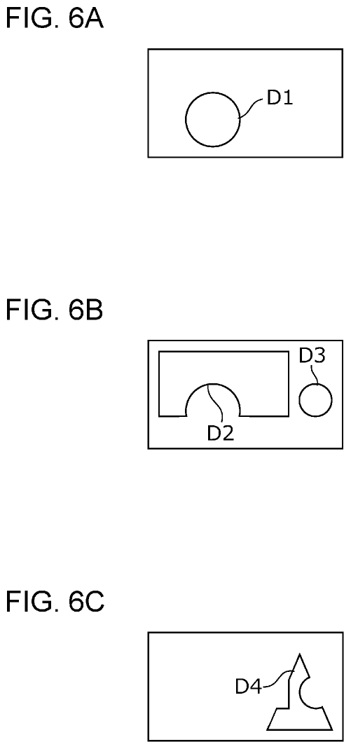

FIGS. 6A to 6C each show an example of a generated vector image. In FIG. 6A, an intermediate image D1 is shown, which is generated based on the outline C1 of the hue area A1. Similarly, in FIG. 6B, intermediate images D2 and D3 are shown, which are generated based on the outlines C2 and C3 of the hue areas A2 and A3. In FIG. 6C, an intermediate image D4 is shown, which is generated based on the outline C4 of the hue area A4. The intermediate image generator 105 supplies the generated intermediate images to the defect determining unit 106.

The defect determining unit 106 integrates the supplied raster images, in other words, the intermediate images generated by the intermediate image generator 105, and determines whether any area in each hue range has a defect.

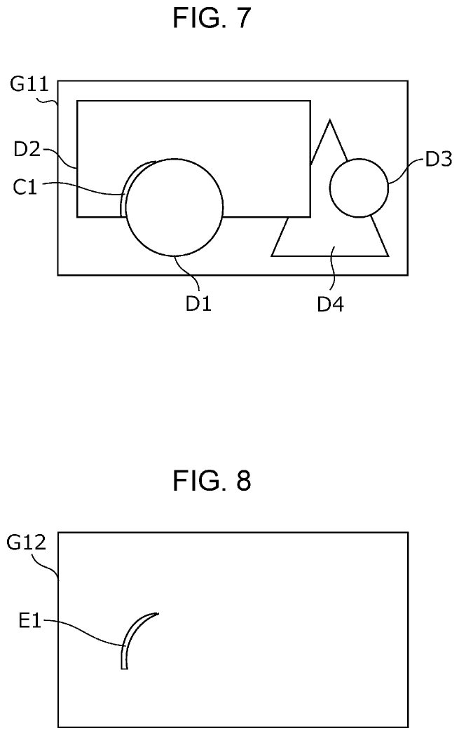

FIG. 7 shows an example of an image obtained by integrating the generated intermediate images. In the example of FIG. 7, an image G1 is shown, which is obtained by integrating the intermediate images D1, D2, D3 and D4.

In the integrated image G1, a defect E1 occurs between the intermediate image D1 and the intermediate image D2. For instance, when the integrated image G1 and the original image G1 are overlapped and no pixel with different pixel values is present, the defect determining unit 106 determines that no defect has occurred, and when a pixel with different pixel values is present, the defect determining unit 106 determines that a defect has occurred. When the defect determining unit 106 determines that a defect has occurred, and the size of the occurred defect is greater than a predetermined size, a defect image showing the defect is supplied to the defect interpolator 107 along with each intermediate image.

FIG. 8 shows an example of an image which illustrates a defect. In the example of FIG. 8, a defect image G12 illustrating the defect E1 only is shown. When a defect image is supplied, in other words, when a defect occurs in a hue area after generated intermediate images are integrated, the defect interpolator 107 performs interpolation processing to interpolate the defect. In the exemplary embodiment, as the interpolation processing, the defect interpolator 107 performs processing to expand the intermediate image in contact with a portion where the defect has occurred.

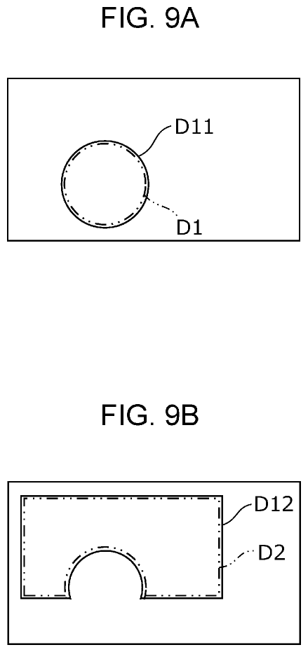

FIGS. 9A and 9B each show an example of an intermediate image which has undergone the expansion processing. The defect interpolator 107 generates an intermediate image D11 obtained by expanding the intermediate image D1 in contact with the defect E1, and similarly generates an intermediate image D12 obtained by expanding the intermediate image D2 in contact with the defect E1. The defect interpolator 107 supplies the generated intermediate images D11 and D12 to the image integrator 108. In addition, the intermediate image generator 105 also supplies generated intermediate images to the image integrator 108.

The image integrator 108 generates an image obtained by integrating the intermediate images based on the intermediate image supplied from the intermediate image generator 105 and the intermediate image after being interpolated supplied from the defect interpolator 107. For interpolated intermediate images, the image integrator 108 integrates the intermediate images after being interpolated, and for not interpolated intermediate images, the image integrator 108 integrates the intermediate images supplied from the intermediate image generator 105. When integration including the intermediate images after being interpolated is performed, the image integrator 108 supplies the generated integrated image to the original image storage 101.

The original image storage 101 stores a supplied integrated image as the original image. Like this, when integration of the generated intermediate images causes a defect in a hue area, the image integrator 108 generates an image obtained by interpolating the defect and the integrating the intermediate images, as the original image. Similarly to the above-described original image, the preprocessing by the pre-processor 102 and the determination of defect by the defect determining unit 106 are performed on the integrated image stored in the original image storage 101 as the original image.

When determining that a defect has not occurred, the defect determining unit 106 notifies the vector image generator 104 of the determination. The vector image generator 104 outputs the original vector image of the integrated image determined to be free of defect to a destination specified, for instance, as the storage location of the vector image converted by the apparatus. No defect occurs in thus stored vector image, even when converted to a raster image.

As described above, when a defect still occurs in the image after being interpolated, the units from the original image storage 101 to the image integrator 108 repeatedly perform interpolation and integration until the defect is reduced to be less than the above-mentioned predetermined size. The image processing apparatus 10 performs processing of converting a raster image to a vector image based on the above-described configuration.

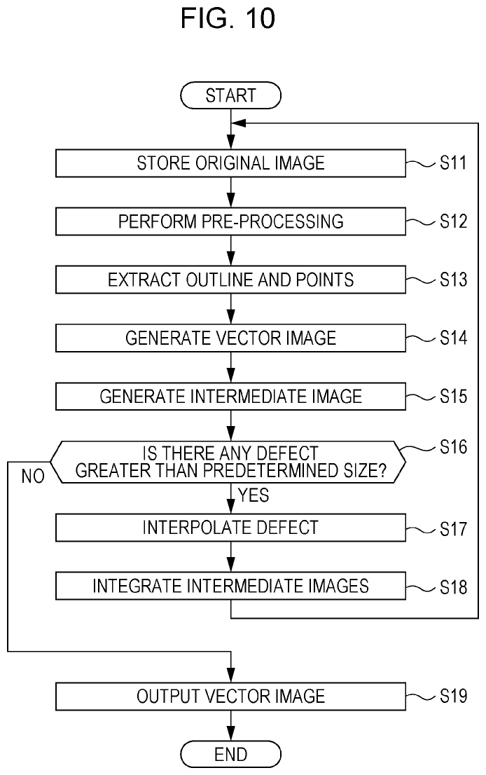

FIG. 10 shows the operation steps of the conversion processing. First, the image processing apparatus 10 (the original image storage 101) stores an original raster image to be converted to a vector image as the original image (step S11). Next, the image processing apparatus 10 (the pre-processor 102) preprocesses the stored original image in a raster format (step S12). Subsequently, the image processing apparatus 10 (the outline extractor 103) extracts the outline of each area shown in the color layers included in the images which have undergone the preprocessing, thereby extracting the outline of each area having a common hue range from the original image in a raster format for multiple hue ranges (step S13).

Next, the image processing apparatus 10 (the vector image generator 104) generates a vector image showing the extracted outline for each area (step S14). Subsequently, the image processing apparatus 10 (the intermediate image generator 105) generates an intermediate image in a raster format using the outline shown by the generated vector image (step S15). Next, the image processing apparatus 10 (the defect determining unit 106) integrates the generated intermediate images, and determines whether any defect is greater than a predetermined size (step S16).

When it is determined that there is a greater defect in step S17, the image processing apparatus 10 (the defect interpolator 107) performs interpolation processing for interpolating the defect (step S17). Next, based on the intermediate image generated in step S15 and the intermediate image interpolated in step S18, the image processing apparatus 10 (the image integrator 108) generates an integrated image obtained by integrating those intermediate images (step S18).

After step S19, the image processing apparatus 10 returns to step S11 and performs its operation. When it is determined that there is no greater defect in step S17, the image processing apparatus 10 (the vector image generator 104) outputs the original vector image of the integrated image determined to be free of greater defect to a destination specified, for instance, as the storage location of the vector image converted by the apparatus (step S19).

In the exemplary embodiment, the outline of each area in a raster image is represented by a vector image by converting the raster image to the vector image. By interpolating a defect as described above, the gap between the outlines represented in both images is reduced, as compared with when the defect is not interpolated. In addition, in the exemplary embodiment, the defect is reliably reduced to be less than the predetermined size by repeatedly performing the interpolation and integration as described above. Additionally, in the exemplary embodiment, the intermediate image in contact with a portion where a defect has occurred is expanded, thus the boundary between the interpolated defect and the intermediate image is unlikely to be recognized.

### [2] Modification

The above-described exemplary embodiment is merely an example of the present disclosure, and may be modified as follows. Alternatively, the exemplary embodiment and each modification may be implemented in a combination as needed.

### [2-1] Interpolation Method

The defect interpolator 107 may interpolate a defect by a method different from the method in the exemplary embodiment. For instance, since the difference area between the image of a hue area extracted by the outline extractor 103 and an intermediate image is a defect area, the defect interpolator 107 identifies the difference area, and interpolates the defect with a color determined based on the color of the portion corresponding to the difference area in the hue area.

It is to be noted that when a defect occurs between an intermediate image and an image in a hue area, the defect interpolator 107 may interpolate the defect with the color of a hue area corresponding to the area of the defect portion. Alternatively, the defect interpolator 107 may interpolate the defect with a color determined based on the color of the intermediate image in contact with a portion where the defect has occurred. In that case, for instance, when a defect has occurred between two or more intermediate images, the defect interpolator 107 interpolates the defect using the intermediate color between the colors of the two or more intermediate images.

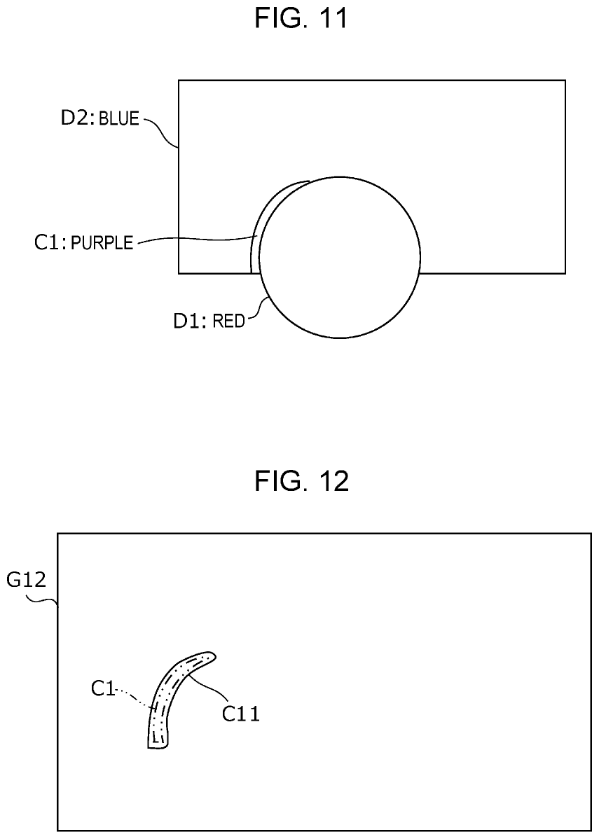

FIG. 11 shows an example of the interpolation processing in the present modification. In the example of FIG. 11, a red intermediate image D1 and a blue intermediate image D2 are in contact with the portion where the defect E1 has occurred. In this case, the defect interpolator 107 interpolates the defect E1 with a color determined based on the color of a portion corresponding to the defect E1 in a hue area. It is to be noted that the method of determining the color of the defect is not limited to this, and the defect interpolator 107 may determine, for instance, that the color of each pixel in the defect is the same as the color of a hue area corresponding to the defect area.

Alternatively, when a defect occurs between two intermediate images, as the color for the defect, the defect interpolator 107 may determine a color which changes stepwise from the color of one intermediate image to the color of the other intermediate image. Alternatively, the defect interpolator 107 may simply determine that the color of each pixel in the defect is the same as the color of the intermediate image closer to the pixel.

Alternatively, the defect interpolator 107 may interpolate the defect by thickening the outline of a vector image in contact with a portion where the defect has occurred. In this case, the defect interpolator 107 requests the vector image to the vector image generator 104, and receives the vector image. The defect interpolator 107 then performs processing of thickening the outline of the received vector image, and supplies the vector image having the thickened outline to the intermediate image generator 105.

The intermediate image generator 105 generates an intermediate image in a raster format using the thickened outline shown by the supplied vector image. Because thus generated intermediate image has the outline thicker than that of the intermediate image before the interpolation, the defect is interpolated accordingly. Consequently, in the same manner as in the exemplary embodiment, the boundary between the interpolated defect and the intermediate image is unlikely to be recognized.

Alternatively, the defect interpolator 107 may interpolate the defect by integrating the intermediate image as well as an image obtained by expanding the portion where the defect has occurred.

FIG. 12 shows an example of an image which illustrates a defect in the present modification. In FIG. 12, the defect interpolator 107 generates the defect image G12 including an expanded image C11 which is obtained by expanding the defect E1 shown by the defect image G12 illustrated in FIG. 8.

The defect interpolator 107 sets the color of an expanded image C11, for instance, the color of an image in a hue area corresponding to the defect E1 to the color of the intermediate image. The defect interpolator 107 supplies the generated defect image G12 to the image integrator 108. The image integrator 108 generates an integrated image obtained by integrating the expanded image C11 included in the supplied defect image G12 and other intermediate images. Specifically, the image integrator 108 superimposes and integrates the intermediate images in contact with the portion, on the image obtained by expanding the portion where the defect has occurred.

For instance, when the defect image G12 is integrated as it is, a gap may further occur between the defect image G12 and an intermediate image. However, as described above, such a gap is unlikely to occur by expanding the defect image G12, as compared with when the defect image G12 is not expanded. In addition, a vector image closer to the original image is generated by superimposing the intermediate images over the expanded image C11, as compared with when the intermediate images are superimposed under the expanded image C11.

### [2-2] Multiple Hue Ranges

Although the pre-processor 102 divides the original image into areas in a predetermined number of hue ranges in the exemplary embodiment, the number of hue ranges for division may be changed. For instance, the pre-processor 102 changes the number of multiple hue ranges according to the degree of deviation of the color of the original image. For instance, the pre-processor 102 first sets the initial value of the number of hue ranges, and divides the original image into areas in the number of hue ranges.

The pre-processor 102 calculates the ratio of the number of pixels of each area in each hue range, and determines the color deviation based on the calculated ratio. For instance, the pre-processor 102 determines the color deviation to be higher for a greater maximum value of the ratio, and sets a higher number of hue ranges for greater color deviation. In that case, the pre-processor 102 uses a hue range table which associates the range of maximum value of the ratio, the color deviation, and the number of hue ranges with each other.

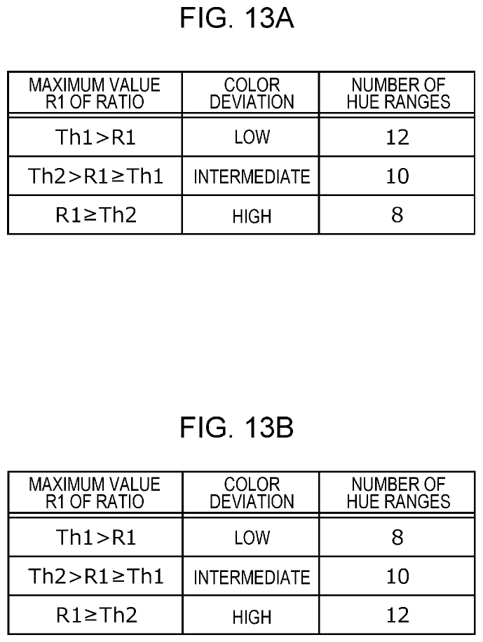

FIGS. 13A and 13B each show an example of a hue range table. In the example of FIG. 13A, the ranges of a maximum value R1 of the ratio, “Th1>R1”, “Th2>R1≥Th1”, “R1>Th2” are associated with the color deviation, “low”, “intermediate”, “high”, and the number of hue ranges, “8”, “10”, “12”, respectively. The pre-processor 102 calculates the ratio with the initial value of “10”, for instance. When the maximum value R1 of the calculated ratio is lower than Th1, the color deviation is “low”, thus the pre-processor 102 determines the number of hue ranges to be decreased to “8”.

When the maximum value R1 of the calculated ratio is higher than or equal to Th2, the color deviation is “high”, thus the pre-processor 102 determines the number of hue ranges to be increased to “12”. In this manner, in the example of FIGS. 13A and 13B, the pre-processor 102 sets a higher number of multiple hue ranges for greater deviation of the color of the original image.

It is to be noted that in the example of FIGS. 13A and 13B, the color deviation is associated for the sake of facilitating the description. However, in the hue range table, only the range of maximum value of the ratio and the number of hue ranges may be associated with each other. Alternatively, the pre-processor 102 may determine the deviation to be higher for a greater dispersion of the ratio, or may determine the deviation to be higher for a smaller percentage of the minimum value in the maximum value of the ratio.

Because the same original image is divided into a greater number of areas for a greater number of hue ranges, a vector image showing more outlines is generated. However, an area with a deviating color tends to be larger for a greater color deviation, and a large defect is likely to occur for a greater area in a hue range. In the example described above, for a greater color deviation, the areas in the hue ranges are generally reduced by increasing the number of hue ranges, thus a large defect is unlikely to occur, as compared with when the number of hue ranges is constant.

It is to be noted that the pre-processor 102 may set a lower number of multiple hue ranges for greater deviation of the color of the original image. In that case, the pre-processor 102 uses the hue range table shown in FIG. 13B.

In FIG. 13B, the color deviation, “low”, “intermediate”, “high” is associated with the number of hue ranges, “12”, “10”, “8”, respectively. The number of multiple hue ranges is reduced for greater deviation of the color of the original image by using the hue range table.

An extremely small area in a hue range is likely to occur for greater deviation of the color, and pixels to show an outline is reduced in number for a smaller area in a hue range, thus the accuracy of the vector image generated by the vector image generator 104 is reduced. In the example of FIG. 13B, the areas in the hue ranges are prevented from being extremely reduced, as compared with when the number of hue ranges is constant, thus reduction in the accuracy of the vector image is inhibited. Like this, in both cases of FIGS. 13A and 13B, the quality of the generated vector image is improved, as compared with when the number of hue ranges is constant.

### [2-3] Functional Configuration

The configuration of the functions implemented by the image processing apparatus 10 is not limited to what is shown in FIG. 2. For instance, although the outline extractor 103 performs both the extraction of outlines and the extraction of points in the exemplary embodiment, these operations may be performed by separate functions.

Alternatively, for instance, the operations performed by the defect determining unit 106 and the defect interpolator 107 may be implemented by a single functional unit. Alternatively, the functions achieved by the image processing apparatus 10 may be implemented by two of more information processing apparatuses or computer resources provided by a cloud service. In short, as long as the functions shown in FIG. 2 are implemented in its entirety, the range of operation performed by each function and the device which implements each function may be freely determined.

### [2-4] Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### [2-5] Category of Disclosure

Not only as the information processing apparatus referred to as the image processing apparatus 10, the present disclosure may also be embodied as an information processing method to implement the processing performed by the information processing apparatus, and may also be embodied as a program which causes a computer to function, the computer being configure to control the information processing apparatus. The program may be provided in the form of a recording medium, such as an optical disc, on which the program is recorded or may be downloaded to a computer via a communication line such as the Internet, and provided in the form of installation to utilize the program.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
extract, for each of a plurality of ranges, an outline of each of areas having a common range of color information from an original image in a raster format,
generate, for each area, an image in a vector format showing the extracted outline,
generate intermediate images in the raster format using the outline shown by the generated image in the vector format, and
when a defect occurs in the area after the generated intermediate images are integrated, generate an image as the original image, the image having undergone interpolation of the defect and integration of the intermediate images.

2. The information processing apparatus according to claim 1, wherein the defect is interpolated by expanding and integrating the intermediate images in contact with a portion where the defect has occurred.

3. The information processing apparatus according to claim 1, wherein the defect is interpolated with a color determined based on a color of one of the intermediate images in contact with a portion where the defect has occurred.

4. The information processing apparatus according to claim 1, wherein the defect is interpolated by thickening an outline of the image in the vector format in contact with a portion where the defect has occurred.

5. The information processing apparatus according to claim 1, wherein the defect is interpolated by integrating an image obtained by expanding a portion where the defect has occurred, along with the intermediate images.

6. The information processing apparatus according to claim 5, wherein the intermediate images in contact with the portion are superimposed and integrated on the image obtained by expanding the portion where the defect has occurred.

7. The information processing apparatus according to claim 1, wherein a number of the plurality of ranges of color information is changed according to a degree of deviation of a color of the original image.

8. The information processing apparatus according to claim 2, wherein a number of the plurality of ranges of color information is changed according to a degree of deviation of a color of the original image.

9. The information processing apparatus according to claim 3, wherein a number of the plurality of ranges of color information is changed according to a degree of deviation of a color of the original image.

10. The information processing apparatus according to claim 4, wherein a number of the plurality of ranges of color information is changed according to a degree of deviation of a color of the original image.

11. The information processing apparatus according to claim 5, wherein a number of the plurality of ranges of color information is changed according to a degree of deviation of a color of the original image.

12. The information processing apparatus according to claim 6, wherein a number of the plurality of ranges of color information is changed according to a degree of deviation of a color of the original image.

13. The information processing apparatus according to claim 1, wherein when the defect still occurs in the image after being interpolated, the interpolation and the integration are repeatedly performed until the defect is reduced to be less than a predetermined size.

14. The information processing apparatus according to claim 2, wherein when the defect still occurs in the image after being interpolated, the interpolation and the integration are repeatedly performed until the defect is reduced to be less than a predetermined size.

15. The information processing apparatus according to claim 3, wherein when the defect still occurs in the image after being interpolated, the interpolation and the integration are repeatedly performed until the defect is reduced to be less than a predetermined size.

16. The information processing apparatus according to claim 4, wherein when the defect still occurs in the image after being interpolated, the interpolation and the integration are repeatedly performed until the defect is reduced to be less than a predetermined size.

17. The information processing apparatus according to claim 5, wherein when the defect still occurs in the image after being interpolated, the interpolation and the integration are repeatedly performed until the defect is reduced to be less than a predetermined size.

18. The information processing apparatus according to claim 6, wherein when the defect still occurs in the image after being interpolated, the interpolation and the integration are repeatedly performed until the defect is reduced to be less than a predetermined size.

19. The information processing apparatus according to claim 7, wherein when the defect still occurs in the image after being interpolated, the interpolation and the integration are repeatedly performed until the defect is reduced to be less than a predetermined size.

20. A non-transitory computer readable medium storing a program causing a computer to execute a process comprising:
extracting, for each of a plurality of ranges, an outline of each of areas having a common range of color information from an original image in a raster format,
generating, for each area, an image in a vector format showing the extracted outline,
generating intermediate images in the raster format using the outline shown by the generated image in the vector format, and
when a defect occurs in the area after the generated intermediate images are integrated, generating an image as the original image, the image having undergone interpolation of the defect and integration of the intermediate images.
